(19) United States
(12) Patent Application Publication
(10) Pub. No.: US 2026/0139964 A1
(43) Pub. Date: May 21, 2026

(54) MAP INFORMATION CREATION DEVICE AND MAP INFORMATION CREATION METHOD

(71) Applicant: HONDA MOTOR CO., LTD., Tokyo (JP)

(72) Inventor: Kazune FURUDO, Tokyo (JP)

(21) Appl. No.: 19/119,413

(22) PCT Filed: Sep. 28, 2023
(86) PCT No.: PCT/JP2023/035391

§ 371 Date: Apr. 9, 2025

(30) Foreign Application Priority Data
Oct. 13, 2022 (JP) 2022-164951

(51) Int. Cl. G01C 21/00

(52) U.S. Cl. CPC G01C 21/3841; G01C 21/3867

(57) ABSTRACT

A map information creation device comprises: a map information storage storing information including center position information of facilities and pieces of parking lot information; a facility information storage storing scale information of the facilities; a parking lot area information table that indicates a correspondence relation between the areas as the scales of the facilities, and the parking lot areas of the facilities typically estimated according to the scales of the facilities; a facility extraction unit that extracts facility information within a predetermined distance from a parking lot; and a parking lot determination unit that, when pieces of facility information are extracted by the facility extraction unit, determines the parking lot as a shared parking lot for facilities if each scale information included in the extracted facility information falls below the scale information of the facility corresponding to the area of the parking lot calculated based on the parking lot area information table.

### TECHNICAL FIELD

The present invention relates to a map information creation device and a map information creation method for easily linking parking lot polygons included in map information and facility information.

### BACKGROUND ART

A use of receiving, with a server, FCD (Floating Car Data) including GPS position information from a plurality of vehicles and utilizing, based on accumulated position information and the like, the FDC for data analysis concerning facilities that the vehicles visited has been spreading. As described in Japanese Unexamined Patent Application, Publication No. 2020-144587, there has been well known a technique of receiving continuous position information from a plurality of vehicles together with hour information, when there is no change in the position information for a predetermined time or more, determining that the vehicles have been parked, and creating a parking position information table in which the position information is recorded as parking positions of the vehicles together with parking times including date and time information. In order to correctly grasp, based on position information of a vehicle, that a vehicle user stopped at, for example, a facility annexed with a parking lot, section information of the parking lot and the parking lot being a parking lot of the relevant facility need to be correctly registered on a map. Parking sections are registered in a map layer in a polygon format. This polygon information can also be registered by requesting an external company to register the polygon information. In an existing OSM (Open Street Map), there are also parking lot polygons already registered. However, it is often unknown whether the respective parking lot polygons are parking lots for facility users annexed to the facility or are parking lots for individuals such as monthly parking lots. Further, in the case of a parking lot annexed to a facility, it is often unknown to which facility the parking lot belongs because facility information and a parking lot grid are not linked.

For example, WO2019-065328 discloses a technique of dividing map information into a plurality of mesh regions, setting, in the mesh regions, a region where vehicles have been parked a plurality of times as a determination target region and determining, as a home parking lot, the mesh region where a specific vehicle has been parked, and determining, as parking lots of a facility, the mesh regions where unspecified large number of vehicles have been parked. However, the technique described in WO2019-065328 discloses that a facility close to latitude and longitude indicating a region of the parking lot determined as the parking lot of the facility is associated with the parking lot. However, when a plurality of facilities are present, parking lot attributes are merely given. The facilities are not specified.

### CITATION LIST

### Patent Document

Patent Document 1: WO2019-065328

Patent Document 2: Japanese Unexamined Patent Application, Publication No. 2020-144587

### DISCLOSURE OF THE INVENTION

### Problems to be Solved by the Invention

In order to enable an analysis of visitors to a facility with, for example, a big data analysis of FCD acquired from vehicles, there have been demands for a map information creation device and a map information creation method that can easily link a parking lot polygon included in map information and facility information.

The present invention has been made in view of such a problem, and an object of the present invention is to provide a map information creation device and a map information creation method for determining, for a plurality of facilities having center position information at a short distance from one node of parking lot polygon information, without relying on human labor, that a parking lot polygon included in map information is a shared parking lot of the plurality of facilities.

### Means for Solving the Problems

(1) A map information creation device (for example, a map information creation device 1 explained below) of the present invention includes:
   a map information storage (for example, a map information storage unit 122 explained below) that stores map information including center position information of a facility as facility information for a plurality of facilities and a plurality of pieces of parking lot polygon information;
   a facility information storage (for example, a facility information storage unit 121 explained below) that stores facility information including size information indicating at least a size of the facility;
   a parking lot area information table (for example, a parking lot area information table 123 explained below) representing a correspondence relation between an area serving as the size of the facility or a range of the area and a parking lot area of a facility standardly assumed according to the size of the facility or a range of the parking lot area;
   a facility extractor (for example, a facility extraction unit 112 explained below) that extracts the facility information having center position information of a facility, a distance of which from one node of the parking lot polygon information is within a predetermined distance; and
   a parking lot determiner (for example, a parking lot determination unit 113 explained below) that determines, when a plurality of pieces of the facility information have been extracted by the facility extractor, when all of pieces of size information included in the pieces of facility information extracted are smaller than size information of a facility associated with an area of the parking lot calculated with reference to the parking lot area information table from the parking lot polygon information, that the parking lot polygon information is a shared parking lot of the plurality of pieces of facility information extracted.

According to above (1), for a plurality of facilities having center position information at a short distance from one node of parking lot polygon information, it is possible to determine, without relying on human labor, that a parking lot polygon included in map information is a shared parking lot of the plurality of facilities.
(2) The map information creation device (for example, the map information creation device 1 explained below) described in above (1) may further include a vehicle parking position information table (for example, a vehicle parking position information table 124 explained below) including at least parking position information, date and time information of parking, and a parking time collected within a predetermined period, the parking position information being position information of a vehicle in a case in which there is no change in position information of the vehicle for a predetermined time or more, and
   the parking lot determiner (for example, the parking lot determination unit 113 explained below) may further plot, in a plurality of grids in the parking lot polygon, parking position information included in the vehicle parking position information table, the parking position information being located in the parking lot polygon determined as the shared parking lot, and determine, as boundary line information of parking lots relating to two different facilities included in the plurality of facilities in the shared parking lot, a grid where a number of pieces of the parking position information plotted for each of the grids changes from decease to increase.

According to above (2), when a parking lot polygon included in map information is a shared parking lot of a plurality of facilities, it is possible to determine, without relying on human labor, a boundary line of parking lots of facilities adjacent to each other in the shared parking lot.
(3) The map information creation device (for example, the map information creation device 1 explained below) described in above (1) may further include: a receiver (for example, a receiving unit 110A explained below) that receives continuous position information from a plurality of vehicles together with hour information; and
   a parking position information recorder (for example, a parking position information recording unit 110B explained below) that determines, when there is no change in the position information for a predetermined time or more, that a vehicle has been parked and stores, in a storage (for example, a storage unit 12 explained below), as a vehicle parking position information table (for example, a vehicle parking position information table 124) , parking position information where it is determined that the vehicle has been parked, and the parking lot determiner (for example, the parking lot determination unit 113 explained below) may further plot, in a plurality of grids in the parking lot polygon, parking position information included in the vehicle parking position information table, the parking position information being located in the parking lot polygon determined as the shared parking lot, and determine, as boundary line information of parking lots relating to two different facilities included in the plurality of facilities in the shared parking lot, a grid where a number of pieces of the parking position information plotted for each of the grids changes from decease to increase.

According to above (3), the same effects as the effects of the map information creation device in (2) are achieved.
(4) A map information creation method of the present invention is a map information creation method executed by a computer, including:
   a map information storing step of storing map information including center position information of a facility as facility information for a plurality of facilities and a plurality of pieces of parking lot polygon information;
   a facility information storing step of storing facility information including size information indicating at least a size of the facility;
   a parking lot area information storing step of storing a correspondence relation between an area serving as the size of the facility or a range of the area and a parking lot area of a facility standardly assumed according to the size of the facility or a range of the parking lot area;
   a facility extracting step of extracting the facility information having center position information of a facility, a distance of which from one node of the parking lot polygon information is within a predetermined distance; and
   a parking lot determining step of determining, when a plurality of pieces of the facility information have been extracted in the facility extracting step, when all of pieces of size information included in the pieces of facility information extracted are smaller than size information of a facility associated with an area of the parking lot calculated with reference to the parking lot area information table from the parking lot polygon information, that the parking lot polygon information is a shared parking lot of the plurality of pieces of facility information extracted.

With the method in above (4), the same effects as the effects of the map information creation device in above (1) are achieved.

### Effects of the Invention

According to the present invention, it is possible to provide a map information creation device and a map information creation method that can determine, for a plurality of facilities having center position information at a short distance from one node of parking lot polygon information, without relying on human labor, that a parking lot polygon included in map information is a shared parking lot of the plurality of facilities.

### BRIEF DESCRIPTION OF THE DRAWINGS

FIG. 1 is a block diagram illustrating a basic configuration of a map information creation device in an embodiment of the present invention;

FIG. 2 is a diagram illustrating an overview of a vehicle parking position information table in the embodiment of the present invention;

FIG. 3 is a diagram illustrating a distance between a facility and a parking lot polygon in the embodiment of the present invention;

FIG. 4 is a diagram illustrating a distribution pattern of the number of parked vehicles in the case in which a boundary line is provided in a shared parking lot to divide the shared parking lot in the embodiment of the present invention to set the shared parking lot as a parking lot allocated to each facility;

FIG. 5 is a diagram illustrating an overview in determining a boundary in the case in which a boundary line is provided in a shared parking lot to divide the shared parking lot in the embodiment of the present invention to set the shared parking lot as a parking lot allocated to each facility;

FIG. 6 is a flowchart illustrating an operation of determining that a parking lot polygon is a shared parking lot of a plurality of facilities and creating a map in the embodiment of the present invention;

FIG. 7 is a flowchart illustrating an operation of determining a boundary of parking lots of two facilities located in the neighborhood in a shared parking lot of a plurality of facilities in the embodiment of the present invention;

FIG. 8 is a block diagram illustrating a basic configuration relating to a modification of the map information creation device in the embodiment of the present invention; and

FIG. 9 is a diagram illustrating an overview of a data structure of a position information database according to a modification of the map information creation device in the embodiment of the present invention.

### PREFERRED MODE FOR CARRYING OUT THE INVENTION

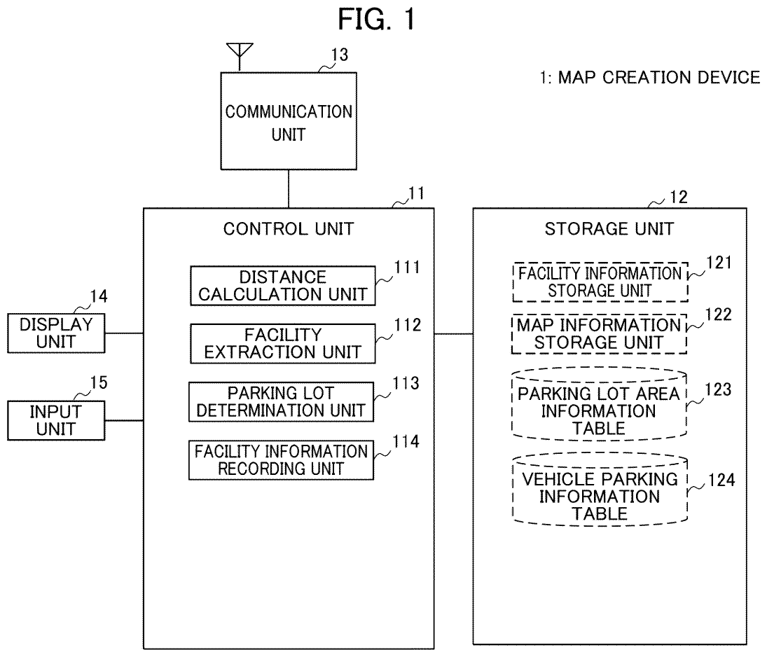

A preferred embodiment of a map information creation device of the present invention is explained in detail below with reference to the figures. A basic configuration of a map information creation device 1 is illustrated in FIG. 1. Functional blocks included in the map information creation device 1 are explained with reference to a block diagram of FIG. 1

As illustrated in FIG. 1, the map information creation device 1 includes a control unit 11, a storage unit 12, a communication unit 13, a display unit 14, and an input unit 15.

The control unit 11 is configured from an arithmetic processing device such as a microprocessor and controls the units configuring the map information creation device 1. Details of the control unit 11 are explained below.

The storage unit 12 is configured by a semiconductor memory or the like and stores programs such as a program for control called firmware or operating system and a program for performing map information creation processing and further stores various kinds of information such as map information. In the figure, as the information stored by the storage unit 12, a facility information storage unit 121 that stores respective facility information for a plurality of facilities, a map information storage unit 122 that stores map information including center position information of the facilities and polygon information of parking lots, a facility parking lot area information table 123, and a vehicle parking position information table 124 are illustrated. Note that, in the embodiment explained below, it is assumed that a coin-operated parking and the like that are not a parking lot of a facility are excluded from a determination target of the present invention in advance. The coin-operated parking and the like are described on a map and can be excluded from the determination target. A parking lot for individuals such as a monthly parking lot can be easily determined based on characteristics; for example, a parking time of parking in the parking lot is long, a parking time at night is particularly long, and the number of vehicles parked at night and the number of parked vehicles calculated from the area of the parking lot are in a close relation. Therefore, the parking lot for individuals can be excluded as a parking lot not included in the determination target of the present invention. The facility information includes, for example, an identification information (a facility ID) of a facility, a name of the facility, a facility type (and/or a genre) concerning a type of the facility, a telephone number, an address, a business hour, center position information indicating a center position (for example, information of latitude and longitude) of the facility, and a size of the facility (for example, a site area of the facility or a total floor area obtained by totaling floor areas of the facility). Here, the facility type indicates a business category of the facility such as a convenience store, a hospital, or a car dealer. The parking lot area information table 123 of the facility indicates a table representing a correspondence relation between an area serving as a size of the facility or a range of the area and a parking lot area of the facility standardly assumed according to the size of the facility or a range of the parking lot area. Note that, for example, a range of the size may be set as the size of the facility in the parking lot area information table 123 and, on the other hand, for example, a range of the area of the parking lot may be associated as the parking lot area of the facility.

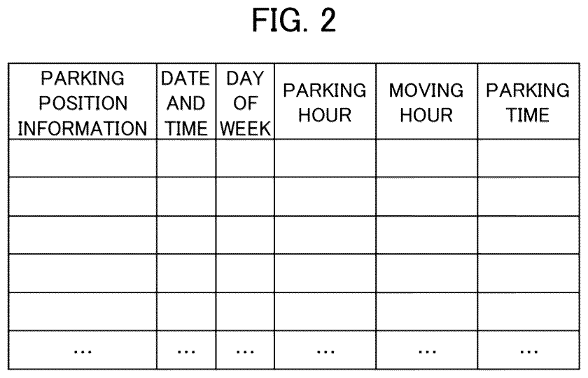

The vehicle parking position information table 124 indicates a table storing vehicle parking information including at least parking position information, date and time information of parking, and a parking time collected in a predetermined region (for example, a prefecture or a municipality) and in a predetermined period (for example, one year). Here, it is assumed that the parking position information is position information of a vehicle in the case in which there is no change in the position information of the vehicle for a predetermined time or more. FIG. 2 is a diagram illustrating an overview of the vehicle parking position information table 124. Note that the vehicle parking position information table 124 is created based on a position information database (not illustrated) including movement transition information created using FCD (Floating Car Data) including a vehicle ID, position information, and hour information received from, for example, a connected car. The creation of the vehicle parking position information table is the publicly-known technique for those skilled in the art as described in, for example, Japanese Unexamined Patent Application, Publication No. 2020-144587. Note that the vehicle ID can be prevented from being included in the vehicle parking position information table 124 from the viewpoint of personal information protection. In the present embodiment, the vehicle parking position information table 124 is configured to be downloaded as appropriate from a server device (not illustrated) connected to a communication network 60. Note that, as a second embodiment of the map information creation device described in a modification 1 explained below, as disclosed in Japanese Unexamined Patent Application, Publication No. 2020-144587, the map information creation device may include a receiving unit 110A and a parking position information recording unit 110B and generate the vehicle parking position information table 124 with the parking position information recording unit 110B.

Note that the facility information, the map information, the parking lot area information table 123, the vehicle parking position information table 124, and the like may be configured to be stored in the storage unit 12 in advance or may be configured to downloaded as appropriate from the server device (not illustrated) connected to the communication network 60. Further, these pieces of information may be corrected as appropriate according to, for example, input of a user. Note that, in the embodiment explained below, it is assumed that a coin-operated parking and the like that are not a parking lot of a facility are excluded from a determination target of the present invention in advance. The coin-operated parking and the like are described on a map and can be excluded from the determination target. A parking lot for individuals such as a monthly parking lot can be easily determined based on characteristics; for example, a parking time of parking in the parking lot is long, a parking time at night is particularly long, and the number of vehicles parked at night and the number of parked vehicles calculated from the area of the parking lot are in a close relation. Therefore, the parking lot for individuals can be excluded as a parking lot not included in the determination target of the present invention.

The communication unit 13 includes a DSP or the like and conforms to a standard such as LTE (Long Term Evolution), 4G (4th Generation), or 5G (5 th Generation) or a standard such as Wi-Fi (registered trademark) and implements wireless communication or wired communication with another device (for example, the server explained above) via the communication network 60. Note that the communication network 60 is implemented by a network such as the Internet or a cellular phone network or a network obtained by combining the Internet and the cellular phone network. A LAN (Local Area Network) may be included in a part of the network.

The display unit 14 is configured by a display device such as a liquid crystal display or an organic electroluminescence panel. The display unit 14 receives an instruction from the control unit 11 and displays an image. The input unit 15 is configured by an input device (not illustrated) such as a physical switch called ten-key pad or a touch panel provided to be superimposed on a display surface of the display unit 14.

Subsequently, details of the control unit 11 are explained. The control unit 11 is configured by a microprocessor including a CPU, a RAM, a ROM, and an I/O. The CPU executes programs read from the ROM or the storage unit 12 and, in the execution of the programs, reads information from the RAM, the ROM, and the storage unit 12, writes information in the RAM and the storage unit 12, and exchanges signals with the communication unit 13. In this way, hardware and software (programs) cooperate, whereby processing in the present embodiment is implemented.

The control unit 11 includes, as functional blocks, a distance calculation unit 111, a facility extraction unit 112, a parking lot determination unit 113, and a facility information recording unit 114.

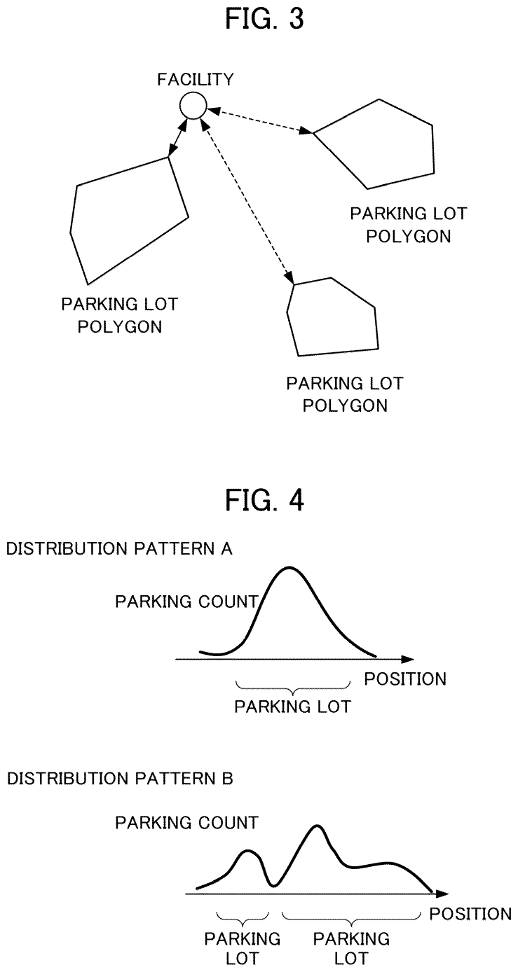

The distance calculation unit 111 calculates a distance between center position information of a facility included in facility information and one node of parking lot polygon information. Here, the one node of the parking lot polygon information means a position included in a parking lot polygon and present at the shortest distance from the center position information of the facility. FIG. 3 is a diagram illustrating a distance between a facility and a parking lot polygon. As illustrated in FIG. 3, the distance between the facility and the parking lot polygon is the shortest distance among distances between the center position of the facility and any positions included in the parking lot polygon. Note that, when the center position of the facility is included in the parking lot polygon, the distance between the center position information of the facility included in the facility information and the one node of the parking lot polygon information is 0 (zero).

The facility extraction unit 112 extracts, for a parking lot having parking lot polygon information selected by the user, facility information having center position information, the distance of which from one node of the parking lot polygon information is equal to or shorter than a predetermined distance.

When the parking lot polygon information includes facility information (for example, a facility ID), the parking lot determination unit 113 determines the parking lot polygon information as a parking lot of a facility identified by the facility ID. When center position information of the facility included in the facility information is included in the parking lot polygon information, the parking lot determination unit 113 determines the parking lot polygon information as a parking lot of the facility. When two or more pieces of facility information have been extracted by the facility extraction unit 112, the parking lot determination unit 113 may refer to the parking lot area information table 123 and determine the parking lot as the parking lot of facility information having size information closest to the size information of a facility associated with the area of the parking lot calculated from the parking lot polygon information.

When a plurality of pieces of facility information have been extracted by the facility extraction unit 112, when all pieces of size information included in the extracted facility information are smaller than size information of a facility associated with an area of parking lot polygon information calculated from the parking lot polygon information with reference to the parking lot area information table 123, the parking lot determination unit 113 may determine the parking lot polygon information as a shared parking lot of the plurality of pieces of facility information extracted by the facility extraction unit 112.

Note that in the case of a shared parking lot of a plurality of pieces of facility information, by providing a boundary line in the shared parking lot and dividing the shared parking lot as a use form of the shared parking lot, it is possible to set the shared parking lot as parking lots allocated to each of facilities. In such a case, a boundary between parking lots of two different facilities can be determined by a method explained below. First, when determining a parking lot as a shared parking lot of a plurality of pieces of facility information, the parking lot determination unit 113 plots, in a plurality of grids in a parking lot polygon determined as the shared parking lot, parking position information included in the vehicle parking position information table 124 and located in the parking lot polygon and calculates the number of pieces of parking position information plotted for each of the grids. Here, the grid is a very small grid of, for example, 1.5 m×1.5 m.

This makes it possible to more finely determine boundary line information of a parking lot. Specifically, the parking lot determination unit 113 counts, based on, for example, a plurality of pieces of parking position information within a predetermined period stored in the vehicle parking position information table 124, for each of the grids, the number of pieces of parking position information included in each of the grids. This makes it possible to calculate, for each of grids included in a section in a predetermined range, the number of vehicles parked in the grid within the predetermined period. The parking lot determination unit 113 may determine, as boundary line information of parking lots relating to two different facilities included in a plurality of facilities in a shared parking lot, a grid where the number of pieces of parking position information plotted for each of the grids changes from decrease to increase.

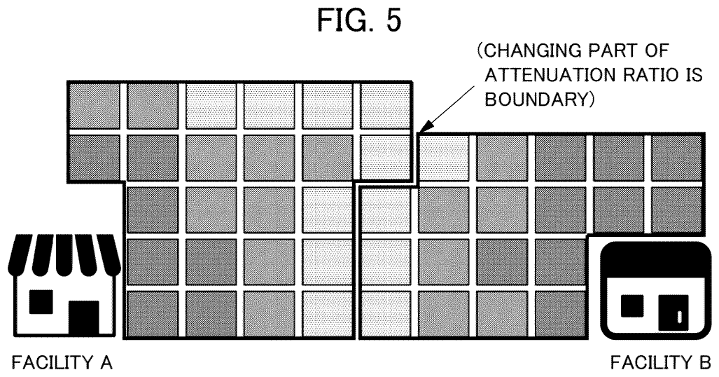

Specifically, the parking lot determination unit 113 may specify, for example, a grid where the number of pieces of parking position information in a grid determined as a parking lot of a facility A changes from decrease to increase. A distribution pattern illustrated in FIG. 4 is a diagram illustrating an overview of a distribution of the number of pieces of parking position information in an adjacent plurality of grids in the case in which parking lots of two facilities are, for example, adjacent across a boundary line. As illustrated in FIG. 4, if a boundary is set between two parking lots, a grid where the number of pieces of parking position information in the grid is minimized can be regarded as the boundary. Then, the parking lot determination unit 113 may regard, as a parking lot of another facility different from one facility, a grid where the number of pieces of parking position information of a grid determined as a parking lot of the one facility changes from decrease to increase and determine shape information of a parking lot of the facility as boundary line information of the parking lots of the facility and the different facility. Specifically, as illustrated in FIG. 5, the parking lot determination unit 113 can refer to grids in order from a facility A side and specify a grid where the number of pieces of parking position information in the grid changes from decrease to increase. Similarly, the parking lot determination unit 113 can refer to grids in order from a facility B side and specify a grid where the number of parking position information in the grid changes from decrease to increase. Accordingly, the parking lot determination unit 113 may determine, as a boundary between both the parking lots, a part where an attenuation ratio of the number of pieces of parking position information in a grid changes (“a changing part of an attenuation ratio”). As explained above, even when, in a shared parking lot of two facilities, the shared parking lot is set as a parking lot allocated to each of the facilities by providing a boundary line and dividing the shared parking lot, the parking lot determination unit 113 is capable of determining a boundary.

The facility information recording unit 114 stores, in the map information storage unit 122, that the plurality of pieces of facility information determined by the parking lot determination unit 113 share one piece of parking lot polygon information. When a boundary line is set for the shared parking lot and the shared parking lot is operated as parking lots of the facilities, the parking lot determination unit 113 can determine the boundary line. As explained above, it is possible to, without linking the shared parking lot of the plurality of pieces of facility information with the parking lot polygon included in the map information and operating the shared parking lot with manual labor, it is possible to create a map in which the parking lot polygon included in the map information is easily linked as the shared parking lot of the plurality of pieces of facility information. The configurations of the functional units of the map information creation device 1 exemplified as the present embodiment are explained above.

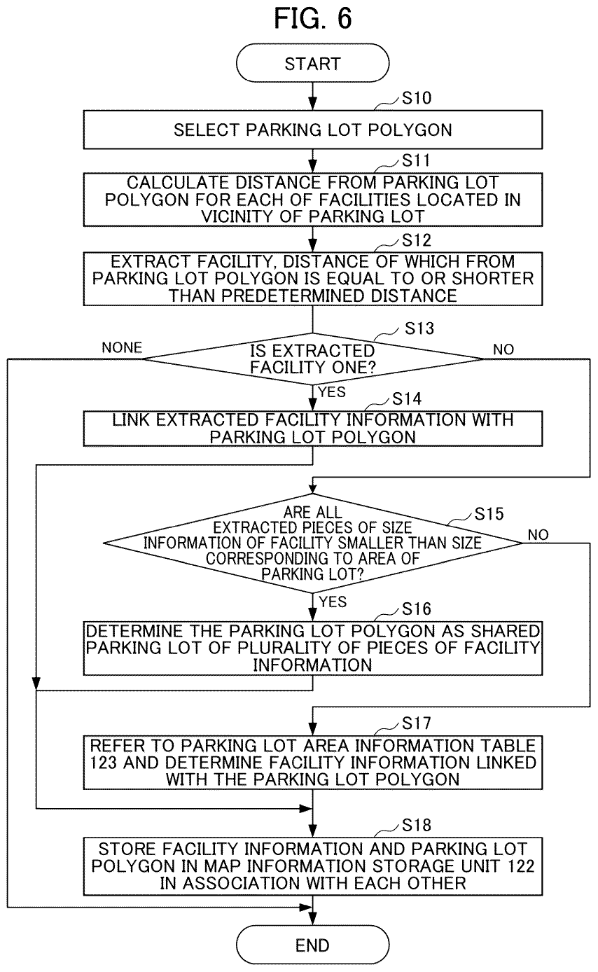

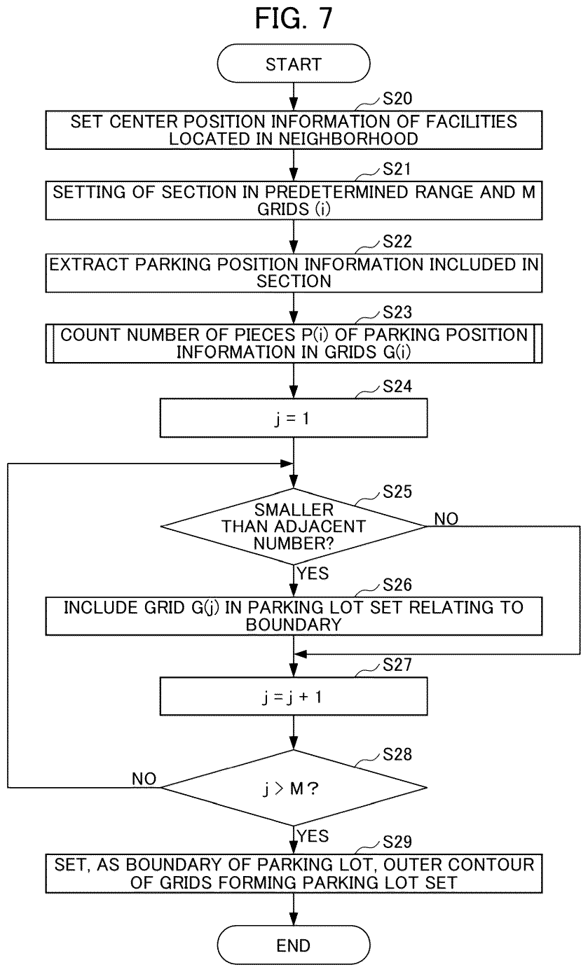

Subsequently, an operation in the present embodiment is explained with reference to flowcharts described in FIG. 6 and FIG. 7. Here, FIG. 6 is a flowchart illustrating an operation of determining that a parking lot polygon is a shared parking lot of a plurality of facilities and creating a map. FIG. 7 is a flowchart illustrating an operation of determining, in a shared parking lot of a plurality of facilities, a boundary between parking lots of two facilities located in the neighborhood. Note that, as explained above, it is assumed that a coin-operated parking and the like that are not a parking lot of a facility are excluded from a parking lot polygon of a determination target. Similarly, as explained above, it is assumed that a parking lot for individuals such as a monthly parking lot is also excluded from a parking lot of a determination target of the present invention. When tag information indicating a facility is present in a parking lot polygon and when the parking lot polygon includes center position information of the facility, it is assumed that the facility information is stored in the map information storage unit 122 in linkage with the parking lot polygon. For this reason, in a processing flow described below, such a parking lot polygon is not included in a target.

Referring to FIG. 6, in step S10, the map information creation device 1 (the parking lot determination unit 113) Selects one parking lot polygon.

In step S11, the map information creation device 1 (the distance calculation unit 111) calculates, for a parking lot having parking lot polygon information selected by the user, a distance from parking lot polygon information for each of facilities located in the vicinity of the parking lot. Specifically, the map information creation device 1 (the distance calculation unit 111) calculates a distance between center position information of the facility and one node of the parking lot polygon information.

In step S12, the map information creation device 1 (the facility extraction unit 112) extracts, for the parking lot having the parking lot polygon information selected by the user, facility information having center position information in which a distance from one node of the parking lot polygon information is equal to or shorter than a predetermined distance.

In step S13, when the facility information extracted in step S12 is one piece of information, the map information creation device 1 (the parking lot determination unit 113) shifts to step S14. When the extracted facility information is two or more pieces of information, the map information creation device 1 (the parking lot determination unit 113) shifts to step S15. Note that, when extracted facility information is absent, the map information creation device 1 (the parking lot determination unit 113) ends the processing.

In step S14, the map information creation device 1 (the parking lot determination unit 113) links the facility information with the parking lot polygon and shifts to step S18.

In step S15, when all pieces of size information included in the extracted facility information are smaller than size information of a facility associated with the area of parking lot polygon information calculated from the parking lot polygon information with reference to the parking lot area information table 123, the map information creation device 1 (the parking lot determination unit 113) shifts to step S16. Otherwise, the map information creation device 1 (the parking lot determination unit 113) shifts to step S17.

In step S16, the map information creation device 1 (the parking lot determination unit 113) determines the parking lot polygon as a shared parking lot of the plurality of pieces of facility information extracted, links the respective plurality of facility information with the parking lot polygon, and shifts to step S18.

In step S17, the map information creation device 1 (the parking lot determination unit 113) determines the parking lot polygon as a parking lot of facility information having size information closest to size information of a facility associated with the area of the parking lot calculated from the parking lot polygon information and links the facility information with the parking lot polygon.

In step S18, the map information creation device 1 (the facility information recording unit 114) stores the parking lot polygon information and the facility information linked with the parking lot polygon information in the map information storage unit 122 in association with each other.

In particular, when a plurality of pieces of facility information is associated with one parking lot polygon, the map information creation device 1 (the facility information recording unit 114) stores the parking lot polygon as a shared parking lot.

Accordingly, by performing the operation explained above on the parking lot polygon included in the map information, the map information creation device 1 can associate the facility information with the parking lot polygon. In particular, when center position information of a plurality of facilities is present in the vicinity of the parking lot polygon, the map information creation device 1 can determine whether the parking lot is a shared parking lot of the plurality of facilities.

Subsequently, with reference to the flowchart described in FIG. 7, an operation of determining a boundary line is explained for a case in which, by providing a boundary line in a shared parking lot of a plurality of facilities and dividing the shared parking lot as a use form of the shared parking lot, the shared parking lot is set as parking lots allocated to each of the facilities.

Referring to FIG. 7, in step S20, the map information creation device 1 (the parking lot determination unit 113) sets center position information of a facility (referred to as “facility A”) and center position information of another facility (referred to as “facility B”) located in the neighborhood.

In step S21, the map information creation device 1 (the parking lot determination unit 113) sets a section in a predetermined range including the center position information of the facility A and the center position information of the facility B and divides the section into a plurality of grids. Here, the number of grids is represented as M and each of the M grids is identified by an index i (1≤i≤M) and represented as G(i).

In step S22, the map information creation device 1 (the parking lot determination unit 113) extracts all pieces of parking position information included in the section set in step S21 (referred to as “intra-section parking position information”) among a plurality of pieces of parking position information in a predetermined period stored in the vehicle parking position information table 124.

In step S23, the map information creation device 1 (the parking lot determination unit 113) counts, based on a set of the intra-section parking position information extracted in step S22, the number of pieces (i) of parking position information included in each grid G(i) with, for example, a counter (i). The number of pieces of parking position information included in the grid G(i) is represented as P(i) (1≤i≤M).

In step S24, the map information creation device 1 (the parking lot determination unit 113) initializes j.

In step S25, the map information creation device 1 (the parking lot determination unit 113) compares the number of pieces P(j) of parking position information included in the grid G(j) with the number of pieces P of parking position information included in a grid adjacent to the grid G(j) and determines the number of pieces P(j) is smaller than the number of pieces P. When the number of pieces P(j) is smaller than the number of pieces P, the map information creation device 1 (the parking lot determination unit 113) shifts to step S26. When the number of pieces P(j) is not smaller than the number of pieces P, the map information creation device 1 (the parking lot determination unit 113) shifts to step S27.

In step S26, the map information creation device 1 (the parking lot determination unit 113) determines the grid G(j) as, for example, a grid located at a boundary between the parking lot of the facility A and the facility B and includes the grid G(j) in a set of grids forming a boundary line.

In step S27, the map information creation device 1 (the parking lot determination unit 113) adds 1 to j.

In step S28, the map information creation device 1 (the parking lot determination unit 113) determines whether j>M. In the case of j>M, the map information creation device 1 (the parking lot determination unit 113) shifts to step S29. In the case of j≤M, the map information creation device 1 (the parking lot determination unit 113) shifts to step S25.

In step S29, the map information creation device 1 (the parking lot determination unit 113) determines, as boundary information between the parking lot of the facility A and the parking lot of the facility B, an aggregate of grids forming the boundary between the parking lot of the facility A and the facility B. Then, the map information creation device 1 (the facility information recording unit 114) stores, in the map information storage unit 122, the boundary information between the parking lot of the facility A and the parking lot of the facility B. The operation of the map information creation device 1, when the two facilities associated with the shared parking lot are located, for example, in the neighborhood, determining the boundary of the parking lot set in each of the facilities in the shared parking lot is explained above. As explained above, even when the two facilities associated with the shared parking lot are located, for example, in the neighborhood, the parking lot determination unit 113 is capable of determining the boundary. Note that, by performing, in the shared parking lot, the operation explained above on all the two facilities adjacent to each other associated with the shared parking lot, the map information creation device 1 can determine boundaries among parking lots of all adjacent facilities. Note that, in the above explanation, the boundary line is determined referring to the adjacent facilities as an example. However, the determination of the boundary line is not limited to this. For example, a boundary may be determined by setting a section in a predetermined range in a shared parking lot, dividing the section into a plurality of grids, and comparing the number of pieces P(j) of parking position information included in the grid G in the predetermined section and the number of pieces P of parking position information included in a grid adjacent to the grid G(j) and determining whether the number of pieces P(j) is smaller than the number of pieces P. Accordingly, for a plurality of facilities having center position information at a short distance from one node of parking lot polygon information, the map information creation device 1 can determine, without relying on human labor, that a parking lot polygon included in map information is a shared parking lot of the plurality of facilities.

According to the present embodiment explained above, for a plurality of facilities having center position information at a short distance from one node of parking lot polygon information, it is possible to determine, without relying on human labor, that a parking lot polygon included in map information is a shared parking lot of the plurality of facilities and, when the parking lot polygon is a shared parking lot of the plurality of facilities and a boundary line is provided in the shared parking lot to divide the shared parking lot as a use form of the shared parking lot, it is possible to determine, without relying on human labor, a boundary line of a parking lot of a different facility in the shared parking lot.

Each of the devices can be implemented by hardware, software, or a combination of the hardware and the software. A map information creation method performed by the devices included in the map information creation device explained above cooperating with one another can also be implemented by hardware, software, or a combination of the hardware and the software. Here, the navigation method being implemented by software means the navigation method being implemented by a computer reading and executing a program.

The program can be stored using non-transitory computer-readable media of various types and supplied to a computer.

The non-transitory computer-readable media include tangible storage media of various types. Examples of the non-transitory computer-readable media include a magnetic recording medium (for example, a flexible disk, a magnetic tape, and a hard disk drive), a magneto-optical recording medium (for example, a magneto-optical disk), a CD-ROM (Read Only Memory), a CD-R, a CD-R/W, a semiconductor memory (for example, a mask ROM, a PROM (Programmable ROM), an EPROM (Erasable PROM), a flash ROM, and a RAM (random access memory) ). The program may be supplied to the computer by transitory computer readable media of various types. An example of the transitory computer readable media include an electric signal, an optical signal, and an electromagnetic wave. The transitory computer-readable media can supply the program to the computer via a wired communication line such as an electric wire and an optical fiber or a wireless communication line.

The embodiment explained above is a preferred embodiment of the present invention. However, the scope of the present invention is not limited to only the embodiment. Implementation in forms applied with various changes in a range not departing from the gist of the present invention is possible.

### Modification 1

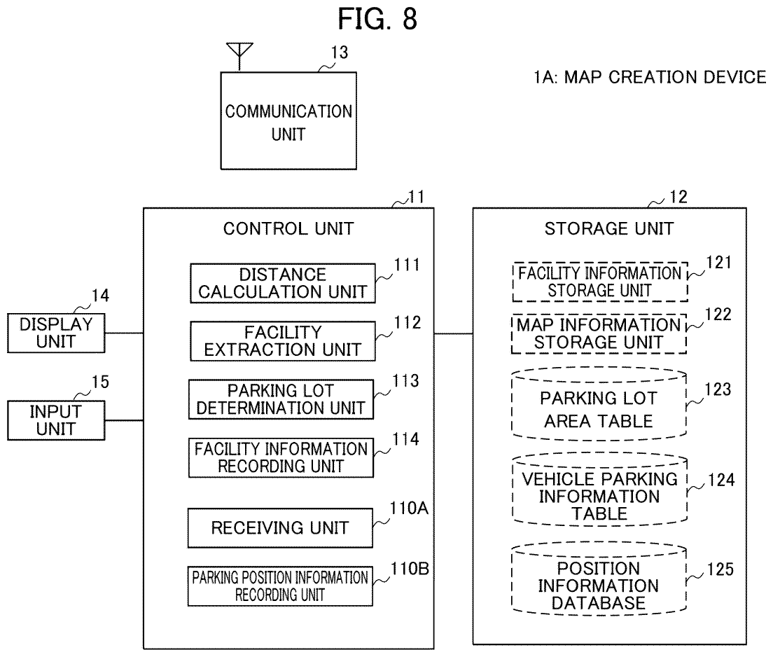

A functional block diagram according to a modification of the map information creation device is illustrated in FIG. 8. In the embodiment explained above, the vehicle parking position information table 124 is configured to be downloaded as appropriate from the server device (not illustrated) or the like connected to the communication network 60. However, as illustrated in FIG. 8, a map information creation device 1A may include, as functional blocks of the control unit 11, in addition to the distance calculation unit 111, the facility extraction unit 112, the parking lot determination unit 113, and the facility information recording unit 114, a receiving unit 110A and a parking position information recording unit 110B. The receiving unit 110A may receive identification information, position information, hour information, and the like of various vehicles from the vehicles via the communication unit 13 and create and update, as appropriate, based on the identification information, the position information, the hour information, and the like received from the vehicles, the position information database 125 representing movement transitions of the vehicles. Based on the position information database 125, when there is no change in the position information for a predetermined time or more, the parking position information recording unit 110B may determine that a vehicle has been parked and store position information of the determination that the vehicle has been parked in the vehicle parking position information table 124 of the storage unit 12 as parking position information. Note that, as explained above, the vehicle ID can be prevented from being included in the vehicle parking position information table 124 from the viewpoint of personal information protection. The receiving unit 110A and the parking position information recording unit 110B are briefly explained below.

The receiving unit 110A receives continuous position information from a plurality of vehicles together with hour information. More specifically, the receiving unit 110A is a portion that updates the position information database 125 based on continuous position information and a vehicle ID (also referred to as mobile body ID) received from a vehicle (also referred to as mobile body) via the communication unit 13.

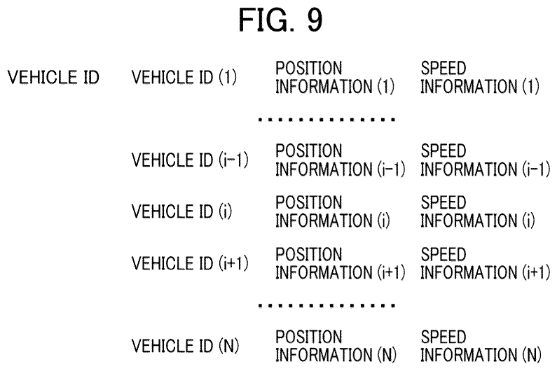

The position information database 125 may be configured to store, for example, position information of a traveling vehicle in at least recent one year. The position information database 125 may be configured to store position information of a traveling vehicle, for example, in prefecture units or region units. As example of a data structure of the position information database 125 is explained with reference to FIG. 9. As illustrated in FIG. 9, the position information database 125 may store “speed information” for each of vehicles in addition to the “vehicle ID” and the “continuous position information and hour information from the vehicles” received by the receiving unit 110A.

The “vehicle ID” in the position information database 125 is, as explained above, information for identifying an on-vehicle navigation device or a portable terminal, which is a transmission source of position information and the like and a vehicle mounted with the on-vehicle navigation device and the portable terminal. The “position information” in the position information database 125 is all pieces of continuous position information from the vehicle received from when transmission of position information and the like was started to the present. The “hour information” is hour information when positioning of the position information was performed. With all of these continuous position information and hour information, it is possible to specify vehicle parking information including a parking position and a parking date and time. Note that, when speed information is transmitted from the vehicle together with the position information, the received speed information is stored in linkage with the hour information and the position information.

When it is determined based on the position information database 125 that there is no change in vehicle position information for a predetermined time or more, the parking position information recording unit 110B determines that the vehicle has been parked. When determining that the vehicle has been parked, the parking position information recording unit 110B calculates a date and a day of week of the parking and a parking hour, a moving hour, and a parking time of the vehicle 50. The parking position information recording unit 110B stores position information where it is determined that the vehicle 50 has been parked as a parking position of the vehicle in the vehicle parking position information table 124. As explained above, the vehicle ID can be prevented from being included in the vehicle parking position information table 124 from the viewpoint of personal information protection. The parking position information recording unit 110B stores, in the vehicle parking position information table 124, parking position information and date and time information (a date and time and a day of week), a parking hour, a moving hour, a parking time, and the like at the parking position as well.

Here, the parking hour indicates an hour when the mobile body has been parked at the parking position and the moving hour indicates an hour when the mobile body has been moved from the parking position. In the vehicle parking position information table 124, for example, a collection period may be set as one year and vehicle parking information may be recorded and accumulated in prefecture units or region units.

More specifically, for example, when, after transmission of position information and the like was once started, position information was received last and predetermined time position information has not been transmitted, the parking position information recording unit 110B may determine that a position corresponding to the position information received last is a parking position. In this case, the parking position information recording unit 110B may calculate, as the parking time of the vehicle, a predetermined time in which position information has not been transmitted. Besides, when a position corresponding to the transmitted position information does not change for a fixed time or more, the parking position information recording unit 110B may determine that the position is the parking position. In this case, the parking position information recording unit 110B may calculate, as a parking time of the vehicle, a time in which the position does not change. When an interval of respective hours when position information adjacent in continuous position information received from the vehicle was measured is longer or equal to or longer than a first time set in advance and shorter than or equal to or shorter than a second time set in advance and any one of pieces of speed information of the adjacent position information is lower than or equal to or lower than predetermined speed Vo set in advance, the parking position information recording unit 110B may determine that the vehicle has been parked. In this case, the parking position information recording unit 110B may calculate, as a parking time of the vehicle, an interval of respective hours when the adjacent position information was measured. Here, the predetermined speed Vo may be set to, for example, a degree of speed at the time when the vehicle is parked in a parking lot. The predetermined speed Vo may be set to 0 km/h. The predetermined speed Vo may be set according to characteristics of each vehicle (characteristics at a driving time of a driver). Accordingly, for example, even if a device is a device that cannot transmit position information at an ignition on time and/or an ignition off time, it can specify information expected as parking. Note that, when the vehicle stops the transmission of the position information of the vehicle according to ignition off, for example, like an on-vehicle navigation device in the current engine car, a current position transmitted immediately before the reception of the position information of the vehicle stopped may be set as the parking position. In this case, the parking position information recording unit 110B may calculate, as the parking time of the vehicle, a time from when the transmission of the position information of the vehicle stopped until the transmission of the position information of the vehicle is started next. Similarly, when the vehicle starts the transmission of the position information of the vehicle according to ignition on, for example, like the on-vehicle navigation device in the current engine car, a current position where the reception of the position information of the vehicle was started may be set as the parking position.

In this case, the parking position information recording unit 110B may calculate, as the parking time of the vehicle, an hour difference from an hour when the transmission of the position information of the vehicle was stopped before reception of the position information of the vehicle is started. Even when the vehicle is stopped like, for example, an electric car, when the vehicle can transmit stop signal information, the parking position information recording unit 110B may set, as the parking position, a current position indicated by a stop signal or most recent position information of position information of the vehicle. In this case, the parking position information recording unit 110B may calculate, as the parking time of the vehicle, a time from when the stop signal information was received until when start signal information or position information is received next. Similarly, when the vehicle can transmit the start signal information at the start time of the vehicle like, for example, an electric car, the parking position information recording unit 110B may set, as the parking position, a current position indicated by a start signal. In this case, the parking position information recording unit 110B may calculate, as the parking time of the vehicle, an hour difference from an hour when stop signal information was received or a position signal was received last before track signal information was received.

### Modification 2

In the embodiment explained above, it is explained that the map information creation device 1 is implemented by one server device or the like. However, a distributed processing system in which the functions of the map information creation device 1 are distributed to a plurality of server devices as appropriate may be adopted. The functions of the map information creation device 1 may be implemented using a virtual server function or the like on the cloud.

### EXPLANATION OF REFERENCE NUMERALS

1 map information creation device
11 control unit
110A receiving unit
110B parking position information recording unit
111 distance calculation unit
112 facility extraction unit
113 parking lot determination unit
114 facility information recording unit
12 storage unit
121 facility information storage unit
122 map information storage unit
123 parking lot area information table
124 vehicle parking position information table
125 position information database
13 communication unit
14 display unit
15 input unit
60 communication network

1. A map information creation device comprising:
a map information storage that stores map information including center position information of a facility as facility information about a plurality of facilities and a plurality of pieces of parking lot polygon information;
a facility information storage that stores facility information including size information indicating at least a size of the facility;
a parking lot area information table representing a correspondence relation between an area serving as a size of the facility or a range of the area and a parking lot area of the facility standardly assumed according to the size of the facility or a range of the parking lot area;
a facility extractor that extracts the facility information having center position information of a facility, a distance of which from one node of the parking lot polygon information is within a predetermined distance; and
a parking lot determiner that, when a plurality of pieces of the facility information is extracted by the facility extractor, when all pieces of size information included in the pieces of facility information extracted are smaller than size information of the facility associated with an area of the parking lot calculated from the parking lot polygon information with reference to the parking lot area information table, determines the parking lot polygon information as a shared parking lot of the plurality of pieces of facility information extracted.

2. The map information creation device according to claim 1, further comprising a vehicle parking position information table including at least parking position information, date and time information of parking, and a parking time collected within a predetermined period, the parking position information being position information of a vehicle in a case in which there is no change in position information of the vehicle for a predetermined time or more, wherein
the parking lot determiner further
plots, in a plurality of grids in the parking lot polygon, parking position information included in the vehicle parking position information table, the parking position information being located in the parking lot polygon determined as the shared parking lot, and determines, as boundary line information of parking lots relating to two different facilities included in the plurality of facilities in the shared parking lot, a grid where a number of pieces of the parking position information plotted for each of the grids changes from decease to increase.

3. The map information creation device according to claim 1, further comprising:
a receiver that receives continuous position information from a plurality of vehicles together with hour information; and
a parking position information recorder that determines, when there is no change in the position information for a predetermined time or more, that a vehicle has been parked, and stores, in a storage, as a vehicle parking position information table, parking position information where it is determined that the vehicle has been parked, and
the parking lot determiner further
plots, in a plurality of grids in the parking lot polygon, parking position information included in the vehicle parking position information table, the parking position information being located in the parking lot polygon determined as the shared parking lot, and determines, as boundary line information of parking lots relating to two different facilities included in the plurality of facilities in the shared parking lot, a grid where a number of pieces of the parking position information plotted for each of the grids changes from decease to increase.

4. A map information creation method executed by a computer, comprising:
a map information storing step of storing map information including center position information of a facility as facility information for a plurality of facilities and a plurality of pieces of parking lot polygon information;
a facility information storing step of storing facility information including size information indicating at least a size of the facility;
a parking lot area information storing step of storing a parking lot area information table representing a correspondence relation between an area serving as the size of the facility or a range of the area and a parking lot area of a facility standardly assumed according to the size of the facility or a range of the parking lot area;
a facility extracting step of extracting the facility information having center position information of a facility, a distance of which from one node of the parking lot polygon information is within a predetermined distance; and
a parking lot determining step of determining, when a plurality of pieces of the facility information have been extracted in the facility extracting step, when all of pieces of size information included in the pieces of facility information extracted are smaller than size information of a facility associated with an area of the parking lot calculated with reference to the parking lot area information table from the parking lot polygon information, that the parking lot polygon information is a shared parking lot of the plurality of pieces of facility information extracted.
